(19) United States
(12) Patent Application Publication
(10) Pub. No.: US 2009/0099896 A1
(43) Pub. Date: Apr. 16, 2009

(54) SYSTEM AND METHOD FOR WORKFLOW DELINQUENCY REMEDIATION

(75) Inventors: Patrick Joseph O'Sullivan, Ballsbridge (IE); Edith Helen Stern, Yorktown Heights, NY (US); Barry E. Willner, Briarcliff Manor, NY (US); Robert Cameron Weir, Westford, MA (US)

Correspondence Address: HOLLAND & KNIGHT, 10 ST. JAMES AVENUE, BOSTON, MA, 02116-3889, US

(73) Assignee: INTERNATIONAL BUSINESS MACHINES CORPORATION, Armonk, NY (US)

(21) Appl. No.: 11/872,155

(22) Filed: Oct. 15, 2007

(51) Int. Cl. G06Q 10/00; G06F 17/40; G06F 19/00

(52) U.S. Cl. 705/9

(57) ABSTRACT

A system and method for workflow delinquency remediation including defining an activity, and defining a time for the activity. The defined activity and time for the activity may be associated with an email. The activity is scheduled in a first calendar associated with at least one email recipient based upon, at least in part, the defined time for the activity.

### TECHNICAL FIELD

This disclosure relates to email communications and, more particularly, to systems and methods for workflow delinquency remediation in email.

### BACKGROUND

Email is widely used for organizing and carrying out collaboration. Despite its convenience and speed, in many respects the mechanisms available to send, receive, and process email do not lend themselves to successful collaboration in a broader context. Often an email may be read and not immediately responded to. With the high volume of email a typical user may receive, the un-responded to email may quickly be forgotten and buried in a list of more recently received email. Even if an email is not inadvertently forgotten, it may nonetheless be ignored by the recipient.

Inadvertent, or otherwise, lack of responsiveness by an email recipient may require many follow-up emails and reminders to keep an assigned or collaborative project on track. Even with repeated reminders, there it cannot be ensured that the email recipient will schedule the necessary time to respond to the action and actually carry out the necessary tasks. Therefore, even though a great deal of time may be spent with follow-up emails and reminders, the additional emails may also not be effective in moving the collaborative project forward.

### SUMMARY OF THE DISCLOSURE

In a first implementation, a method includes defining an activity and defining a time for the activity. The activity and time are associated with an email. The activity is scheduled in a first calendar associated with at least one email recipient based upon, at least in part, the defined time for the activity.

One or more of the following features may be included. The activity may have an associated task to be performed by, at least in part, the at least one email recipient. The defined time for the activity may be a time duration. Scheduling the activity in the first calendar may include scheduling one or more time periods in the first calendar, in which the one or more time periods have an aggregate duration equal to at least the dime duration. The defined time for the activity may be a specified time. Scheduling the activity in the first calendar may include waiting a predetermined period of time before scheduling the activity in the first calendar.

The activity may be scheduled in a second calendar. The second calendar may be associated with one or more of an email sender, at least a second email recipient, or a third party. Scheduling the activity in the second calendar may include scheduling a common time in the first calendar and the second calendar.

The email recipient may be notified of the scheduled activity.

According to another implementation, a computer program product may reside on a computer readable medium and may have a plurality of instructions stored thereon. When executed by a processor, the instructions may cause the processor to perform operations including defining an activity, and defining a time for the activity. The activity and the defined time for the activity may be associated with an email. The activity may be scheduled in a first calendar associated with at least one email recipient based upon, at least in part, the defined time for the activity.

One or more of the following features may be included. The activity may have an associated task to be performed by, at least in part, the at least one email recipient. The defined time for the activity may be a time duration. The instructions for scheduling the activity in the first calendar may include instructions for scheduling one or more time periods in the first calendar, the one or more time periods having an aggregate duration equal to at least the time duration. The defined time for the activity may be a specified time. The instructions for scheduling the activity in the first calendar may include instructions for waiting a predetermined period of time before scheduling the activity in the first calendar.

Instructions may be included for scheduling the activity in a second calendar. The second calendar may be associated with one or more of an email sender, at least a second email recipient, or a third party. The instructions for scheduling the activity in the second calendar may include instructions for scheduling a common time in the first calendar and the second calendar.

Instructions may be included for notifying the email recipient of the scheduled activity.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts a workflow delinquency remediation process and an email application coupled to a distributed computing network.

FIG. 2 is a flowchart of a process executed by the workflow delinquency remediation process of FIG. 1.

FIG. 3 is a diagrammatic view of an email template rendered by the workflow delinquency remediation process and/or the email application of FIG. 1.

FIG. 4 is a diagrammatic view of an email template rendered by the workflow delinquency remediation process and/or the email application of FIG. 1.

FIG. 5 is a diagrammatic view of an email template rendered by the workflow delinquency remediation process and/or the email application of FIG. 1.

FIG. 6 is a diagrammatic view of an email template rendered by the workflow delinquency remediation process and/or the email application of FIG. 1.

FIG. 7 is a diagrammatic view of a calendar rendered by the workflow delinquency remediation process and/or the email application of FIG. 1.

FIG. 8 is a diagrammatic view of a calendar rendered by the workflow delinquency remediation process and/or the email application of FIG. 1.

FIG. 9 is a diagrammatic view of a calendar rendered by the workflow delinquency remediation process and/or the email application of FIG. 1

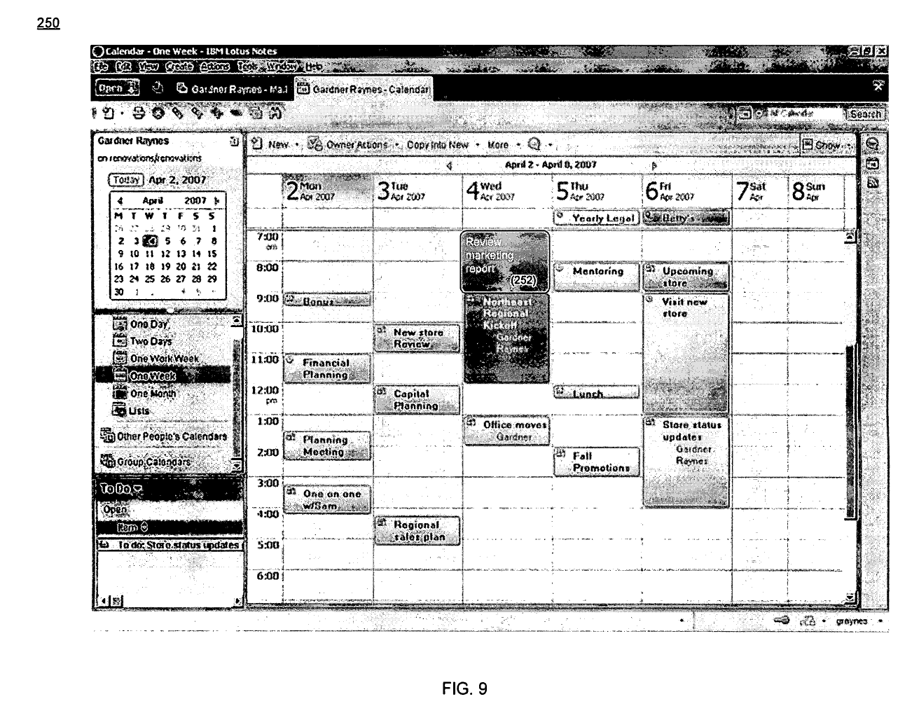

### DETAILED DESCRIPTION

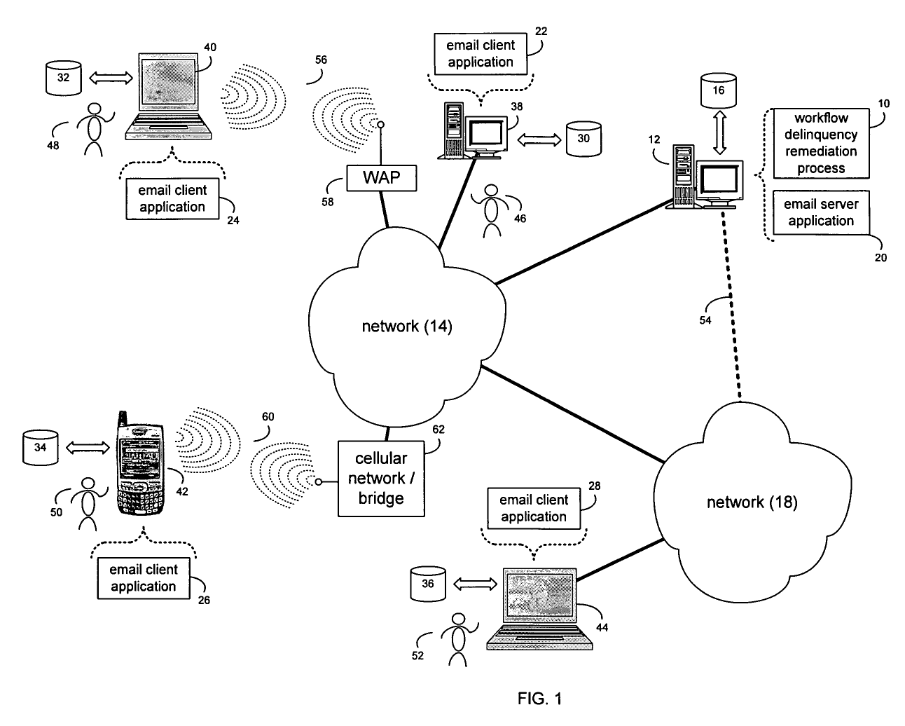

Referring to FIG. 1, there is shown workflow delinquency remediation process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Alternatively, workflow delinquency remediation process may reside on a client electronic device, such as a personal computer, notebook computer, personal digital assistant, or the like. As will be discussed below in greater detail, workflow delinquency remediation process 10 may allow an email sender to define an activity and define a time for the activity. The activity and the time may be associated with an email. The activity may be scheduled in a calendar associated with an email recipient based upon, at least in part, the defined time for the activity.

The instruction sets and subroutines of workflow delinquency remediation process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute email server application 20, examples of which may include but are not limited to IBM Lotus Domino™ Server and Microsoft Exchange™ Server. Email server application 20 may be a mail transfer agent that may store and route email to one or more email client applications 22, 24, 26, 28, examples of which may include but are not limited to IBM Lotus Notes™ and Microsoft Outlook™. Workflow delinquency remediation process 10 may be a stand alone application that interfaces with email server application 20 or may be an applet/application that is executed within email server application 20.

The instruction sets and subroutines of email server application 20, which may be stored on storage device 16 coupled to server computer 12, may be executed by one or more processors (not shown) and one or more memory architectures (not shown) incorporated into server computer 12.

In addition/as an alternative to being a server-based application residing on server computer 12, the workflow delinquency remediation process may be a client-side application (not shown) residing on one or more client electronic device 38, 40, 42, 44 (e.g., stored on storage device 30, 32, 34, 36, respectively). As such, the workflow delinquency remediation process may be a stand alone application that interfaces with an email client application, or may be an applet/application that is executed within email client application. As such, the workflow delinquency remediation may be a client-side process, a server-based application, or a hybrid client-side/server-based process, which may be executed, in whole or in part, by email client application and/or email server application.

The instruction sets and subroutines of email client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and a memory stick storage devices. Examples of computing devices 38, 40, 42, 44 may include, but are not limited to, personal computer 38, laptop computer 40, personal digital assistant 42. notebook computer 44, a data-enabled, cellular telephone (not shown), and a dedicated network device (not shown), for example. Using email client applications 22, 24, 26, 28, users 46, 48, 50, 52 may access email server application 20 and may send, retrieve and/or organize email messages.

Users 46, 48, 50, 52 may access email server application 20 directly through the device on which the email client application (e.g., email client applications 22, 24, 26, 28) is executed, namely client electronic devices 38, 40, 42, 44, for example. Users 46, 48, 50, 52 may access email server application 20 directly through network 14 or through secondary network 18. Further, server computer 12 (i.e., the computer that executes email server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### Workflow Delinquency Remediation Process

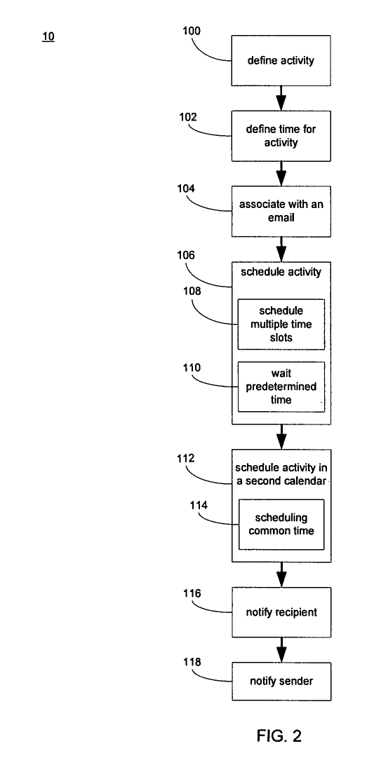

Referring also to FIG. 2, workflow delinquency remediation process 10 may allow a user to define 100 an activity and define 102 a time for the activity. The user may associate 104 the activity and the time with an email. The activity may be scheduled 106 in a first calendar associated with at least one email recipient based upon, at least in part, the defined 102 time for the activity.

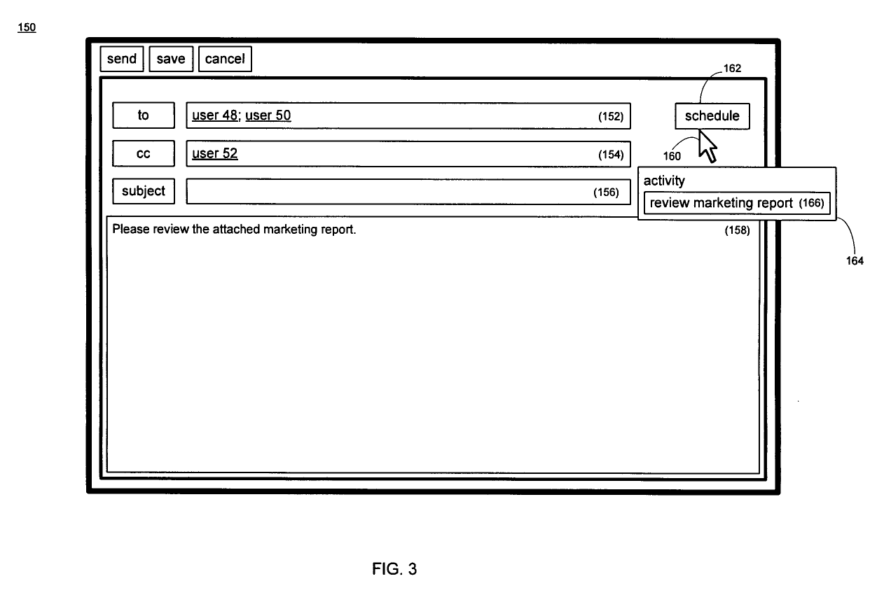

Referring also to FIG. 3, user 46 may, for example, create an email using email client application 22. To create the email, email client application 22 may render email template 150, which may include, but is not limited to, recipient fields (e.g., “to” field 152, “cc” field 154, “bcc” field; not shown), subject field 156, as well as message body block 158. The email may include a new email originally created by user 46, or a forwarded email, e.g., originating with another user and which is forwarded by user 46.

User 46 may address the email message to one or more email recipients, e.g., using one or more of “to” field 152 and “cc” field 154. Recipients of the email message may be defined in various ways. For example, user 46 may select one of the recipient fields (e.g., “to” field 152 or “cc” field 154) by positioning onscreen pointer 160 in the field using a pointing device (e.g., mouse; not shown) and clicking. User 46 may then type the email address(es) of the intended recipient(s) in one of the recipient fields. Alternatively, user 46 may define recipients of the email message, e.g., using a contacts list, or similar directory. For the particular example shown in FIG. 1, user 46 may define users 48, 50, 52 as recipients of the email message by placing their email addresses (namely: user 48; user 50; and user 52) in recipient fields (i.e., in “to” field 152, and “cc” field 154).

Workflow delinquency remediation process 10 may allow user 46 to define 100 one or more activities, e.g., to be associated 104 with the email. The activity may include an associated task, such as, attend a meeting, prepare a document, review a document, for example. For example, user 46 may email a request for users 48, 50, 52 to review a marketing report. User 46 may, therefore, define 100 an activity “review marketing report”, including an associated task of reviewing a marketing report. User 46 may define 100 the activity for the email in general (i.e., the activity may be the same for all recipients of the email), or may define 100 the activity on a recipient-by-recipient bases (e.g., allowing different activities to be defined for individual recipients).

As shown in FIG. 3, workflow delinquency remediation process 10 may allow user 46 to define 100 an activity for all recipients of the email, e.g., by selecting “schedule” button using onscreen pointer 160 controlled by the pointing device (e.g., mouse; not shown). Selecting “schedule” button 162 may result in workflow delinquency remediation process 10 rendering popup menu 164. Popup menu 164 may include activity field 166, in which user 46 may define 100 an activity associated 104 with the email (e.g., by typing “review marketing report” in activity field 166 using a keyboard; not shown).

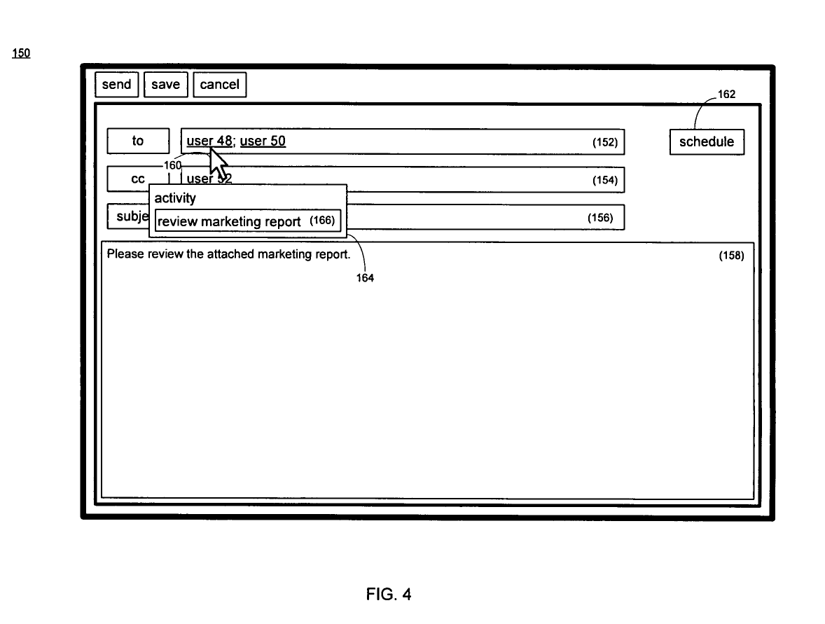

Referring also to FIG. 4, in a related manner, user 46 may be allowed to define 100 an activity associated with individual recipients of the email. For example, user 46 may select an individual recipient, e.g., using onscreen pointer 160 to select the recipient's email address, and “right clicking,” which may result in workflow delinquency remediation process 10 rendering popup menu 164 associated with an individual recipient, e.g., user 48. As described above, popup menu 164 may include activity field, in which user 46 may define 100 the activity.

Once user 46 has defined 100 the activity, workflow delinquency remediation process 10 may allow user 46 to define 102 a time for the activity. The time for the activity may be a time duration, or may be a specified time. For example, a time duration for the activity may be an estimated time necessary to complete the activity or task associated with the activity. The time for the activity may be a specified time, e.g., a specific time (or time slot) on a specific day (e.g., of a given month, or on a recurring basis) for the activity, or a time before or after which the activity may occur.

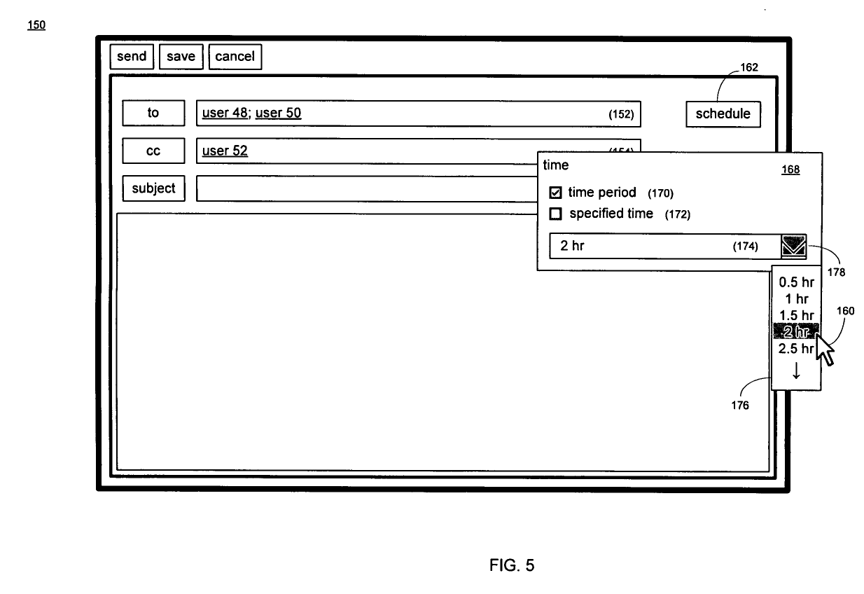

Referring also to FIG. 5, once user 46 has defined 100 the activity, workflow delinquency remediation process 10 may render additional popup menu 168, which may allow user 46 to define 102 the time for the activity. Popup menu 168 may define options including, but not limited to, “time period” and “specified time”, e.g., in form of check boxes 170, 172. User 46 may, for example, select (using onscreen point 160 controlled by the pointing device, e.g., mouse; not shown) “time period” check box 170, to specify a time period for the activity (e.g., a time duration for the activity). User 46 may then input a time period (e.g., in the form of a number of minutes, hours, or days for completing the activity) in time entry field 174. User 46 may activate time entry dropdown menu 176, e.g., by clicking on down arrow 178 using onscreen pointer 160 controlled by the pointing device (e.g., mouse; not shown). User 46 may define 102 the time for the activity by selecting a desired estimated (e.g., by user 46) time for completing the activity (e.g., 2 hrs.) from dropdown menu 176.

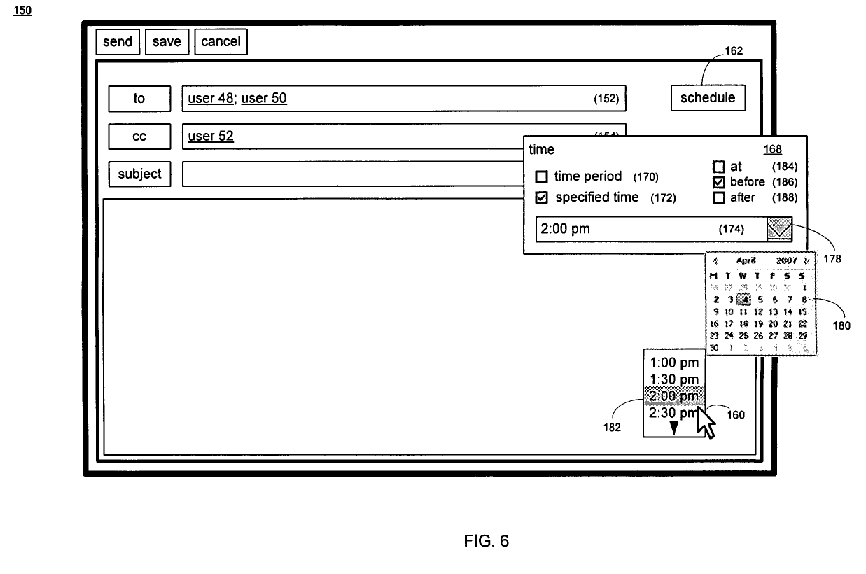

With additional reference to FIG. 6, user 46 may define 102 a time for the activity in terms of a specified time by selecting “specified time” check box 172 (e.g., using onscreen pointer 160 controlled by the pointing device, e.g., a mouse; not shown). Once “specified time” check box 172 has been selected, user 46 may input the specified time for the activity. For example, user 46 may select down arrow 178 in time entry field 174, resulting in workflow delinquency remediation process 10 rendering calendar dropdown menu 180. User 46 may select (e.g., using onscreen pointer 160 controlled by a pointing device, such as a mouse; not shown) a specified date, and time (e.g., via rendered time popup 182). As such, user 46 may define 102 a specified time for the defined 100 activity (e.g., 2:00 pm on Wednesday, April 4^{th}).

In addition to allowing user 46 to define 102 a time for the activity in terms of a specified time, workflow delinquency remediation process 10 may allow user 46 to specify whether the activity should be completed at the specified time (e.g., by selecting “at” check box 184), before the specified time (e.g., by selecting “before” check box 186), or after the specified time (e.g., by selecting “after” check box 188). For example, as shown in FIG. 6, user 46 may select “before” check box 186, indicating that that activity should be completed before the specified time. In this example, the specified time may be a deadline for completing the activity.

Furthermore, workflow delinquency remediation process 10 may allow user 46 to define 102 a time for the activity in terms of duration and specified time. For example, as discussed with reference to FIG. 5, user 46 may specify a time period for the activity by selecting “time period” check box 170 and inputting a time period (e.g., in time entry field 174). User 46 may also specify a time for the activity by also (either before or after specifying a timer period for the activity) selecting “specified time” check box 172. As described with reference to FIG. 6, user 46 may input the specified time for the activity using time entry field 174 and/or calendar drop down menu 180 and time popup 182. In the foregoing manner, both a time duration and a specified time for the activity may be defined.

As described above, workflow delinquency remediation process 10 may allow user 46 to define 100 an activity and define 102 a time for the activity. Workflow delinquency remediation process 10 may associate 104 the defined 100 activity and defined time 102 with the email, e.g., as a result of the activity and time being defined 100, 102 within the email template 150.

Once the user has defined 100 the activity and defined 102 a time for the activity, and workflow delinquency remediation process 10 has associated 104 the activity and the time for the activity with the email, workflow delinquency remediation process 10 may schedule 106 the activity in a calendar of one or more recipient of the email based upon, at least in part, the time defined for the activity. Workflow delinquency remediation process 10 may schedule 106 the activity in the calendar of one or more recipient of the email as soon as the email is sent by a sender of the email. Alternatively, workflow delinquency remediation process 10 may schedule 106 the activity in the calendar of one or more email recipient when the email recipient receives and/or opens the email.

In order to schedule 106 the activity on a calendar of one or more recipients of the email, workflow delinquency remediation process 10 may access a calendar of the one or more email recipient and schedule 106 the activity based upon, at least in part, the defined 102 time for the activity, which may include a time period and/or a specified time, as discussed above. For example, the specified time may provide a deadline for completing the activity and the time period may provided an estimated time duration for completing the activity. The calendar of the one or more email recipient may be, for example, a calendar or scheduling module of the email recipient's email client application (e.g., email client applications 22, 24, 26, 28) or an email server application (e.g., email server application 20) accessible by the user (e.g., users 46, 48, 50, 52).

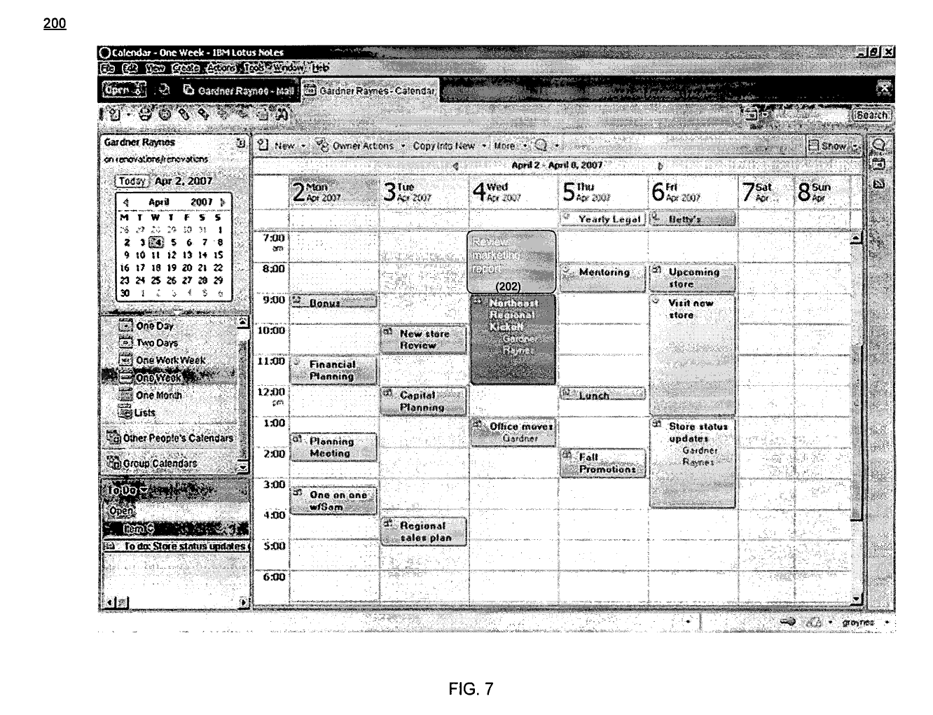

Referring also to FIG. 7, and continuing with the above-stated example of FIG. 5, user 46 may have defined a time period of two hours to “review marketing report”. Workflow delinquency remediation process 10 may access a calendar of user 48 and may schedule 106 a two hour period of time on Wednesday, April 4^{th} for user 48 to “review marketing report”. In this manner, workflow delinquency remediation process 10 may schedule 106 the activity “review marketing report” in user 48's calendar as a two hour event based upon, at least in part, the defined 102 two hour time duration estimated for reviewing the marketing report. As shown, scheduled event “review marketing report” 202 may appear on calendar 200 (as rendered by email client application 24 and/or workflow delinquency remediation process 10) associated with user 48.

Similarly, and continuing with the example of FIG. 6, workflow delinquency remediation process 10 may schedule 106 the defined 100 activity “review marketing report” in the calendar associated with user 48 based upon, at least in part, the defined 102 time for the activity, which may include a specified time before which the activity should be completed. As shown, the scheduled 106 activity “review marketing report” may appear as scheduled event “review marketing report” 202 at 7:00 am on Wednesday, April 4^{th}, i.e., before the defined 102 time of 2:00 pm on Wednesday, April 4^{th} on calendar 200 (as rendered by email client application 24 and/or workflow delinquency remediation process 10) associated with user 48. In this manner, the defined time 102 (i.e., the specified time) may be a deadline, and workflow delinquency remediation process 10 may schedule 106 the activity to be completed prior to the deadline.

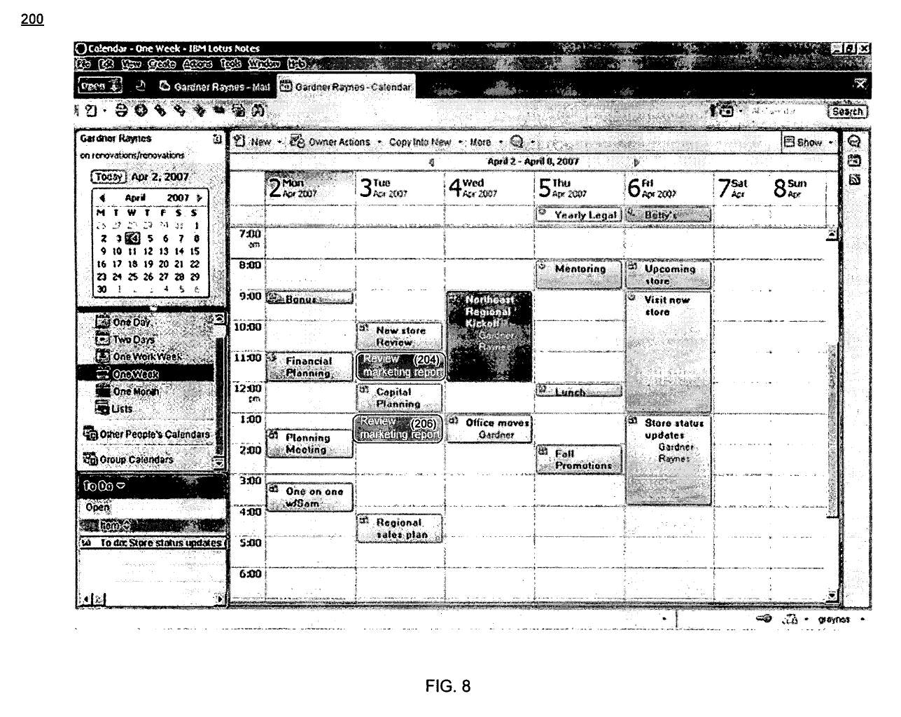

Due to scheduling conflicts, user preferences, or the like, it may not be possible to schedule 106 the activity in a single time period. In such an instance, workflow delinquency remediation process 10 may schedule 108 more than one period of time in the email recipient's calendar for the activity. The more than one period of time scheduled 108 in the email recipient's calendar may have an aggregate duration equal to a defined time duration for the activity. For example, continuing with the example of FIG. 5 in which user 46 specified a two hour time duration for the activity, workflow delinquency remediation process 10 may divide the two hour time defined 102 for “review marketing report” into more than one scheduled event on the calendar associated with user 48. As shown in FIG. 8, workflow delinquency remediation process 10 may schedule 108 two one hour events 204, 206 designated “review marketing report” calendar 200 (as rendered by email client application 24 and/or workflow delinquency remediation process 10) associated with user 48, thereby breaking the activity into multiple time slots.

Workflow delinquency remediation process 10 may wait 110 a predetermined time before the activity is scheduled 106 in the first calendar. For example, the email recipient may be granted a period of time for completing the activity on his own (e.g., a grace period) before the time for completing the activity is scheduled 106 in the calendar associated with the email recipient. Continuing with the above-stated example, if user 48, for example, completes the task associated with the activity (e.g., reviews marketing report) within a predetermined period of time, workflow delinquency remediation process 10 may not schedule 106 the activity in the calendar associated with user 48, as the need to schedule the time is rendered moot by user 48's completion of the task. Continuing with the above-stated example, user 46 may define the predetermined time period for completing the activity before workflow delinquency remediation process 10 schedules 106 the activity in the calendar associated with user 48. The predetermined time period for completing the activity may be defined, for example, in a manner similar to that used to define the time for the activity.

Workflow delinquency remediation process 10 may also schedule 112 the activity in at least a second calendar, e.g., associated with a second defined user. That is, workflow delinquency remediation process 10 may schedule the defined 100 activity in multiple calendars. The second calendar may be associated with, for example, another recipient of the email, the sender of the email, or a third party. The time in which the activity is scheduled 112 in the second calendar may be different than the time in which the activity is scheduled 106 in the first calendar.

In another example, the defined 100 activity may require a collaborative effort by more than one person. In such an example, workflow delinquency remediation process 10 may schedule 114 common time for the activity in the first calendar and the second calendar. Continuing with the above-stated example of FIG. 7, workflow delinquency remediation process 10 may schedule 114 the activity at 7:00 am on Wednesday, April 4^{th} (e.g., as shown by event 252 in calendar 250, rendered by email client application 26 of user 50 and/or workflow delinquency remediation process 10), i.e., the same time scheduled 106 for user 48.

Workflow delinquency remediation process 10 may notify 116 the email recipient that the activity has been scheduled 106 in the calendar associated with the email recipient. Continuing with the above-stated example, workflow delinquency remediation process 10 may, for example, notify 116 user 48 that time has been scheduled in the calendar associated with user 48 for “review of marketing report”. Notification may be via the email with which the activity and time are associated. Additionally/alternatively, user 48 may be separately notified 116 of the scheduled activity, e.g., via another email, instant message, text message, automated voicemail, or other notification.

Workflow delinquency remediation process 10 may notify 118 the sender of the email of progress concerning the activity. For example, the recipient of the email may reschedule or cancel the time scheduled 106 for the activity. Workflow delinquency remediation process 10 may notify 118 the sender of the email of such actions by the email recipient. Workflow delinquency remediation process 10 may also notify 118 the sender of the email of various other attributes and activities concerning the activity and/or the time scheduled 106 for the activity including, but not limited to, completion, dismissal, rescheduling, passing of scheduled time, an the like. Workflow delinquency remediation process 10 may notify 118 the sender of the email, e.g., via email, instant message, automated voicemail, text message, for example.

A number of implementations have been described. Nevertheless, it will be understood that various modifications may be made. Accordingly, other implementations are within the scope of the following claims.

What is claimed is:

1. A method comprising:
defining an activity;
defining a time for the activity;
associating the activity and the time for the activity with an email;
scheduling the activity in a first calendar associated with at least one email recipient based upon, at least in part, the defined time for the activity.

2. The method of claim 1, wherein the activity has an associated task to be performed by, at least in part, the at least one email recipient.

3. The method of claim 1, wherein the defined time for the activity is a time duration.

4. The method of claim 3, wherein scheduling the activity in the first calendar includes scheduling one or more time periods in the first calendar, the one ore more time periods having an aggregate duration equal to at least the time duration.

5. The method of claim 1, wherein the defined time for the activity is a specified time.

6. The method of claim 1, wherein scheduling the activity in the first calendar includes waiting a predetermined period of time before scheduling the activity in the first calendar.

7. The method of claim 1, further including scheduling the activity in a second calendar based upon, at least in part, the defined time for the activity.

8. The method of claim 7, wherein the second calendar is associated with one or more of an email sender, at least a second email recipient, or a third party.

9. The method of claim 7, wherein scheduling the activity in the second calendar includes scheduling a common time for the activity in the first calendar and the second calendar.

10. The method of claim 1, further including notifying the email recipient of the scheduled activity.

11. A computer program product residing on a computer readable medium having a plurality of instructions stored thereon which, when executed by a processor, cause the processor to perform operations comprising:
defining an activity;
defining a time for the activity;
associating the activity and the time for the activity with an email;
scheduling the activity in a first calendar associated with at least one email recipient based upon, at least in part, the defined time for the activity.

12. The computer program product of claim 11, wherein the activity has an associated task to be performed by, at least in part, the at least one email recipient.

13. The computer program product of claim 11, wherein the defined time for the activity is a time duration.

14. The computer program product of claim 13, wherein the instructions for scheduling the activity in the first calendar include instructions for scheduling one or more time periods in the first calendar, the one or more time periods having an aggregate duration equal to at least the time duration.

15. The computer program product of claim 11, wherein the defined time for the activity is a specified time.

16. The computer program product of claim 11, wherein the instructions for scheduling the activity in the first calendar include instructions for waiting a predetermined period of time before scheduling the activity in the first.

17. The computer program product of claim 11, further including instructions for scheduling the activity in a second calendar.

18. The computer program product of claim 17, wherein the second calendar is associated with one or more of an email sender, at least a second email recipient, or a third party.

19. The computer program product of claim 17, wherein the instructions for scheduling the activity in the second calendar include instructions for scheduling a common time for the activity in the first calendar and the second calendar.

20. The computer program product of claim 11, further including instructions for notifying the email recipient of the scheduled activity.
